(19) United States
(12) Patent Application Publication
(10) Pub. No.: US 2018/0060407 A1
(43) Pub. Date: Mar. 1, 2018

(54) DATA-DEPENDENCY-DRIVEN FLOW EXECUTION

(71) Applicant: LinkedIn Corporation, Mountain View, CA (US)

(72) Inventors: Eric Li Sun, Fremont, CA (US); Shirshanka Das, San Jose, CA (US)

(73) Assignee: LinkedIn Corporation, Mountain View, CA (US)

(21) Appl. No.: 15/249,841

(22) Filed: Aug. 29, 2016

(51) Int. Cl. G06F 17/30; H04L 12/801

(52) U.S. Cl. CPC G06F 17/30575; H04L 47/10; G06F 17/30371

(57) ABSTRACT

The disclosed embodiments provide a system for managing execution of a data flow. During operation, the system obtains a data dependency description for a data flow, wherein the data dependency description includes data sources to be consumed by the data flow, data targets to be produced by the data flow, and one or more data ranges associated with the data sources and the data targets. Next, the system uses the data dependency description to determine an availability of the data sources in an execution environment. After the availability of the data sources in the execution environment is confirmed, the system generates output for initiating execution of the data flow in the execution environment.

### BACKGROUND

### Field

The disclosed embodiments relate to data processing. More specifically, the disclosed embodiments relate to techniques for performing data-dependency-driven flow execution.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, data analytics may be used to assess past performance, guide business or technology planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools, relational databases, and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, complex data processing flows may involve numerous interconnected jobs, inputs, and outputs, which may be difficult to coordinate in a way that satisfies all dependencies in the flows.

Consequently, big data analytics may be facilitated by mechanisms for efficiently collecting, storing, managing, compressing, transferring, sharing, analyzing, processing, defining, and/or visualizing large data sets.

### BRIEF DESCRIPTION OF THE FIGURES

FIG. 1 shows a schematic of a system in accordance with the disclosed embodiments.

FIG. 2 shows a system for managing execution of a data flow in accordance with the disclosed embodiments.

FIG. 3 shows an exemplary data lineage for a data flow in accordance with the disclosed embodiments.

FIG. 4 shows a flowchart illustrating the process of managing execution of a data flow in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

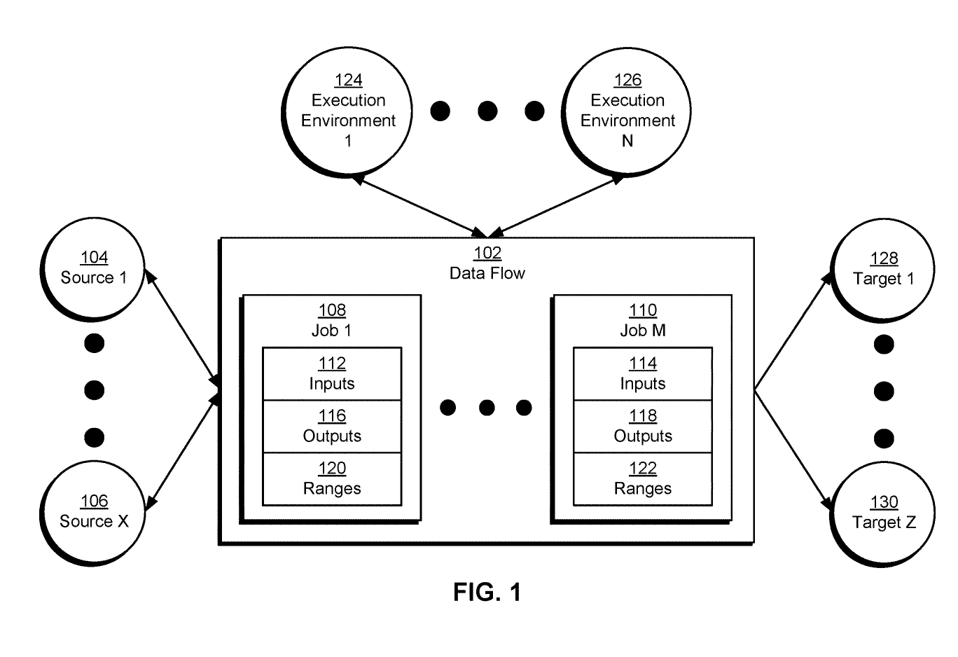

The disclosed embodiments provide a method, apparatus, and system for facilitating data processing. As shown in FIG. 1, such processing may be performed within a data flow 102 that executes in a number of execution environments (e.g., execution environment 1 124, execution environment n 126). For example, the data flow may be used to perform Extract, Transform, and Load (ETL), batch processing, and/or real-time processing of data in data centers, clusters, colocation centers, cloud-computing systems, and/or other large-scale data processing systems.

Within data flow 102, a number of jobs (e.g., job 1 108, job m 110) may execute to process data. Each job may consume data from one or more inputs 112-114 and produce data to one or more outputs 116-118. Multiple data flows may also be interconnected in the same and/or different execution environments. For example, jobs in the data flow may consume a number of data sets produced by other jobs in the same data flow and/or other data flows, and produce a number of data sets for consumption by other jobs in the same data flow and/or other data flows.

In addition, jobs in data flow 102 may be connected in a pipeline, such that the output of a given job may be used as the input of another job. For example, the pipeline may include obtaining data generated by a service from an event stream, storing the data in a distributed data store, transforming the data into one or more derived data sets, and outputting a subset of the derived data in a reporting platform.

The jobs may also operate on specific ranges 120-122 of data in inputs 112-114 and/or outputs 116-118. For example, each job may specify a required time range of data to be consumed from one or more inputs (e.g., data from the last day or the last hour). The job may also specify a time range of data to be produced to one or more outputs.

Inputs 112-114 and outputs 116-118 of the jobs in data flow 102 may also be aggregated into a set of sources (e.g., source 1 104, source x 106) and a set of targets (e.g., target 1 128, target z 130) for the data flow. The sources may represent data sets that are required for the data flow to execute, and the targets may represent data sets that are produced by the data flow. For example, the sources may include all data sets that are consumed but not produced by jobs in the data flow, and the targets may include all data sets that are produced by some or all jobs in the data flow. As with job-level inputs and outputs, the sources and targets may be associated with ranges of data to be respectively consumed and produced by the data flow.

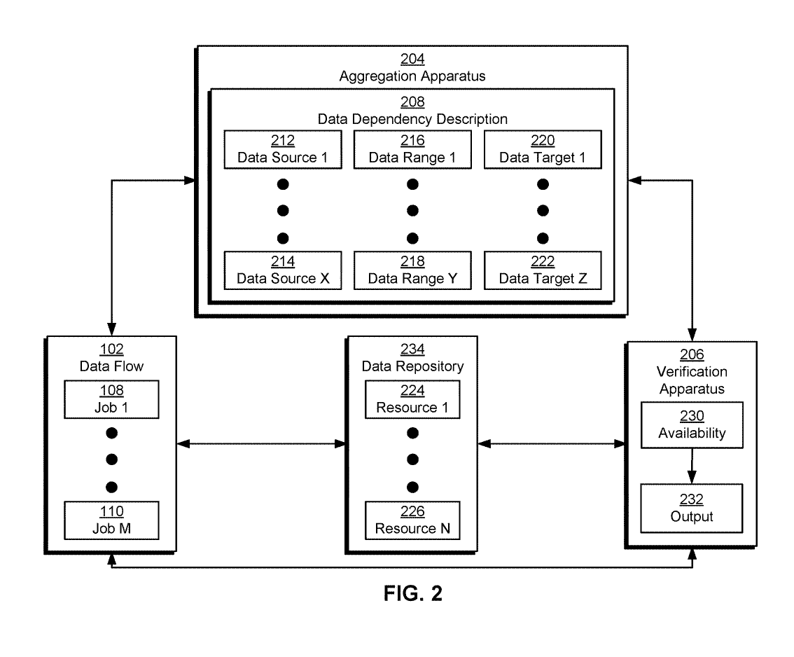

In one or more embodiments, execution of data flow 102 in one or more execution environments is facilitated by identifying and resolving data dependencies associated with the sources, targets, and jobs in the data flow. As shown in FIG. 2, the data dependencies may be captured in a data dependency description 208 for the data flow.

Data dependency description 208 may include a set of data sources (e.g., data source 1 212, data source x 214), a set of data targets (e.g., data target 1 220, data target z 222), and a set of data ranges (e.g., data range 1 216, data range y 218) associated with some or all of the data sources and/or data targets. As mentioned above, the data sources may include data sets that are required to execute data flow 102, and the data targets may include data sets that are produced by jobs in the data flow, including data sets consumed by other jobs in the data flow. Data ranges of the data sources may represent requirements associated with a time range, partition range, and/or other range of data in the data sources, and data ranges of the data targets may represent time ranges, partition ranges, and/or other ranges of data to be outputted in the data targets. For example, a data source may have a required data range that spans five hours and ends in the last hour before the current time. In another example, a data range of a data target may span a 24-hour period that ends 12 hours before the current time.

An aggregation apparatus 204 may generate data dependency description 208 using information from a number of sources. For example, aggregation apparatus 204 may track the execution of the jobs and/or obtain information for configuring or describing the jobs to identify data sets consumed and/or generated by the jobs. The aggregation apparatus may combine the execution and/or job information with data models, data hierarchies, and/or other metadata associated with data sets in the data flow to populate the data dependency description with the data sources, data targets, and/or data ranges. The data dependency description may also include data lineage information associated with the data flow, such as a partial or complete ordering of jobs and/or data in a pipeline represented by the data flow. Finally, the data dependency description may include input from a developer, such as additions, modifications, and/or deletions of data ranges associated with the data sources and/or data targets.

After data dependency description 208 is created, a verification apparatus 206 may determine an availability 230 of data sources in the data dependency description in an execution environment such as a server, virtual machine, cluster, data center, cloud computing system, and/or other collection of computing resources. To assess the availability of each data source, the verification apparatus may identify a resource (e.g., resource 1 224, resource n 226) containing a data set representing the data source in a data repository 234. For example, the verification apparatus may use identifying information for the data source in the data dependency description to obtain the corresponding data set from a file, directory, disk, cluster, distributed data store, database, analytics platform, reporting platform, application, data warehouse, and/or other source of data that is accessible to the jobs in data flow 102.

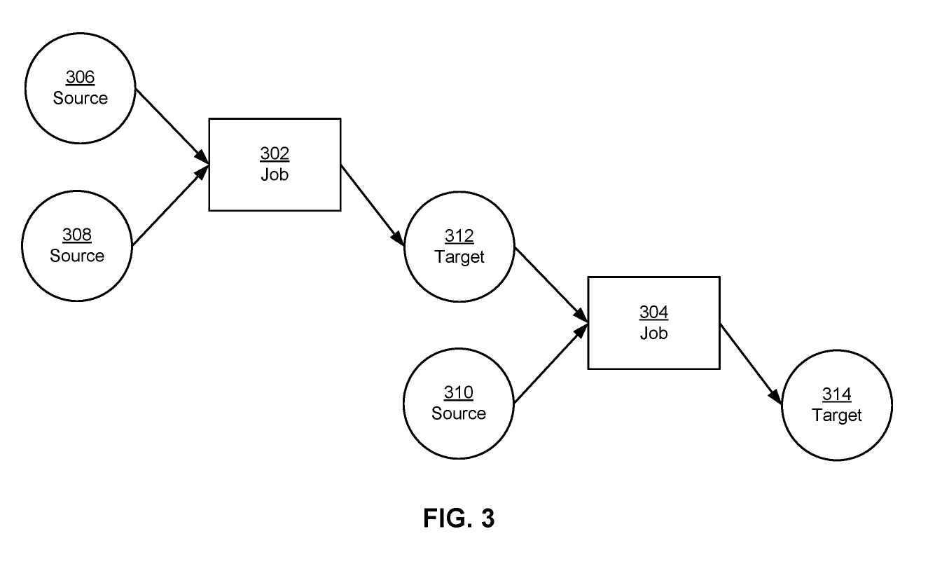

After a data set corresponding to a data source in data dependency description 208 is identified, verification apparatus 206 may verify a data range of the data source in the data set, if the data range is specified in the data dependency description. For example, the verification apparatus may examine logs, transactions, and/or data values associated with the data set to verify that the data set contains the required data range for the data source. Using data dependency descriptions to verify data source availability in execution environments is described in further detail below with respect to FIG. 3.

After availability 230 is confirmed for all data sources and the corresponding data ranges, verification apparatus 206 may generate output 232 for initiating execution of data flow 102 in the execution environment. For example, the verification apparatus may output a notification and/or indication of a “data availability” for executing the data flow in the execution environment. Alternatively, the verification may output a signal to initiate the data flow in the execution environment (e.g., by triggering the execution of one or more jobs at the beginning of the data flow).

Output 232 may also be used to coordinate execution of data flow 102 in multiple execution environments. For example, each execution environment may maintain a separate copy or set of data sources used by the data flow. When availability 230 of the data sources is confirmed in the execution environment, an instance of verification apparatus 206 in the execution environment may output a notification of the availability and/or readiness of the data flow to execute in the execution environment. If the data flow is available to execute on multiple execution environments, instances of the verification apparatus and/or another component in the execution environments may perform load balancing of the data flow across the execution environments and/or selectively execute the data flow in a way that maximizes the utilization of computational resources in the execution environments. On the other hand, if the data flow is available to execute in only one execution environment, the instances may coordinate the replication of data targets produced by the data flow from the execution environment to the other execution environment(s).

Finally, output 232 may be used to confirm successful execution of data flow 102 and/or individual jobs in the data flow. For example, verification apparatus 206 may confirm the successful creation of the data targets after the data flow and/or corresponding jobs have completed execution. The verification apparatus may also verify that the data targets contain or meet the data ranges specified in data dependency description 208. The verification apparatus may then report one or more attributes of the data targets, such as an identifier, time of completion, and/or data range for each target. The reported attributes may then be used by the verification apparatus to verify availability 230 of other data sources to be consumed by other data flows in the execution environment, such as data sources represented by the data targets. The reported attributes may additionally or alternatively be used to trigger the replication of the data targets from the execution environment to other execution environments in which the data flow executes.

By declaring and resolving data dependencies of data flow 102 before the data flow executes, the system of FIG. 2 may reduce the incidence of failures resulting from execution of the data flow. The verification of data availability 230 and/or the successful creation of the data targets by the data flow may additionally facilitate the coordination or management of downstream jobs, the execution of the data flow on multiple execution environments, and/or the replication of the data targets across the execution environments.

Those skilled in the art will appreciate that the system of FIG. 2 may be implemented in a variety of ways. First, aggregation apparatus 204, verification apparatus 206, and/or data repository 234 may be provided by a single physical machine, multiple computer systems, one or more virtual machines, a grid, one or more databases, one or more filesystems, and/or a cloud computing system. The aggregation and verification apparatuses may additionally be implemented together and/or separately by one or more hardware and/or software components and/or layers.

Second, the functionality of aggregation apparatus 204 and/or verification apparatus 206 may be adapted to the management of other types of dependencies and/or data processing. For example, job-level dependencies may be used by the aggregation apparatus and verification apparatus to trigger the execution of individual jobs in data flows and/or coordinate the execution of jobs across multiple execution environments. In another example, the system of FIG. 2 may also be used to manage the execution of data flows based on other types of dependencies, such as job dependencies (e.g., dependency of one job on the initiation, successful completion, or termination of another job), time dependencies (e.g., dependencies related to scheduling of jobs), and/or event dependencies (e.g., dependencies on internal or external events by the jobs).

FIG. 3 shows an exemplary data lineage for a data flow (e.g., data flow 102 of FIG. 1) in accordance with the disclosed embodiments. As shown in FIG. 3, the data lineage may include two jobs 302-304, three sources 306-310, and two targets 312-314. Job 302 may consume sources 306-308 and produce target 312, and job 304 may consume target 312 and source 310 and produce target 314.

As a result, the data lineage of FIG. 3 may describe both data and job dependencies in the data flow. For example, the data lineage may indicate that job 302 has data dependencies on sources 306-308, job 304 has data dependencies on source 310 and target 312, and job 304 has a job dependency on job 302.

The data lineage may also be represented in a data dependency description for the data flow, such as data dependency description 208 of FIG. 2.

As described above, the data dependency description may specify data sources 306-310 to be consumed by the data flow, data targets 312-314 to be produced by the data flow, and/or data ranges associated with the sources and/or targets. For example, the data lineage of FIG. 3 may include the following exemplary data dependency description:

```
{
  “owner”: “johnsmith”,
  “name”: “DataTriggerUnitTest”,
  “ruleSet”: {
    “expression”: “R1 and (R2 or R3)”,
    “ruleList”: [{
      “name”: “R1”,
      “@type”: “HDFS”,
      “cluster”: “eat1-nertz”,
      “resourceUri”: “/data/databases/Identity/Profile”,
      “adjustments”: [
        {“unit”: “Day”, “value”: “−1”},
        {“unit”: “Second”,“value”: “!1”},
        {“unit”: “Minute”,“value”: “+1”}
      ],
      “dataEndTime”: “yesterday( ) America/Los_Angeles”,
      “beyondDataEndTime”: “true”
    }, {
      “name”: “R2”,
      “@type”: “HDFS”,
      “cluster”: “eat1-nertz”,
      “resourceUri”:
          “/data/tracking/PageViewEvent/hourly_deduped/($yyyy)/
          ($MM)/($dd)/($HH)”,
      “adjustments”: [
        {“unit”: “Hour”, “value”: “−1”},
        {“unit”: “Second”,“value”: “!0”},
        {“unit”: “Minute”,“value”: “!0”}
      ],
      “range”: {“unit”: “hour”, “value”: 5},
      “dataEndTime”: “lastHour( ) America/Los_Angeles”
    }, {
      “name”: “R3”,
      “@type”: “HDFS”,
      “cluster”: “eat1-nertz”,
      “resourceUri”:
          “/data/tracking/PageViewEvent/hourly/($yyyy)/($MM)/
          ($dd)/($HH)”,
      “adjustments”: [
        {“unit”: “Hour”, “value”: “−1”},
        {“unit”: “Second”,“value”: “!0”},
        {“unit”: “Minute”,“value”: “!0”}
      ],
      “range”: {“unit”: “hour”, “value”: 5},
      “dataEndTime”: “2016-03-28 17:00:00 America/Los_Angeles”
    }]
  },
  “sla”: {“@type”: “TIMED_SLA”, “unit”: “Minute”,
  “duration”: 100}, “successNotifications”: [{
    “@type”: “email”,
    “toList”: [“johnsmith”, “tombrody”, “evansilver”]
  }],
  “failureNotifications”: [{
    “@type”: “email”,
    “toList”: [“tombrody”, “dwh_operation”]
  }],
  “outputList”: [{
    “name”: “Xyz”,
    “@type”: “HIVE”,
    “resourceUri”: “job_pymk.member_profile_view”,
    “partition”: “yesterday( )”
  }, {
    “name”: “Pqr”,
    “@type”: “HIVE”,
    “resourceUri”: “job_pymk.member_position”
  }]
}
```

The exemplary data dependency description includes three sources named “R1,” “R2,” and “R3,” along with a requirement that “R1” and either of “R2” and “R3” be available (i.e., “expression”: “R1 and (R2 or R3)”). For example, “R1” may represent source 310, and “R2” and “R3” may represent sources 306-308, respectively.

“R1” may refer to a data set with a path of “/data/databases/Identity/Profile” in a Hadoop Distributed Filesystem (HDFS) cluster named “eat1-nertz.” “R1” may also have a data range of the previous day in a given time zone (i.e., “yesterday( )America/Los_Angeles”). “R2” may refer to a data set with a path that matches the regular expression of “/data/tracking/PageViewEvent/hourly_deduped/($yyyy)/($MM)/($dd)/($HH)” in the same HDFS cluster. “R2” may include a data range that spans five hours and ends in the hour before the current time (i.e., “range”: {“unit”: “hour”, “value”: 5}, “dataEndTime”: “lastHour( )America/Los_Angeles”). “R3” may refer to a data set with a path that matches the regular expression of “/data/tracking/PageViewEvent/hourly/($yyyy)/($MM)/($dd)/($HH)” in the same HDFS cluster. While “R3” also has a data range of five hours, the data range ends at a specific time (i.e., “2016-03-28 17:00:00 America/Los_Angeles”) instead of a time that is relative to the current time.

The data dependency description also includes two targets named “Xyz” and “Pqr,” which may represent targets 312-314. The “Xyz” target may have a type of “HIVE” and a Uniform Resource Identifier (URI) of “job_pymk.member_profile_view” in a partition named “yesterday( )” indicating that the target produces data with a data range corresponding to the previous day. The “Pqr” target may have a type of “HIVE,” a URI of “job_pymk.member_position,” and no data range.

The data dependency description may be used to verify the availability of the sources before executing the data flow and to confirm the creation of the targets after the data flow has finished executing. For example, the data dependency description may be used to verify that the data set represented by “R1” exists and has the corresponding data range, and that either data set represented by “R2” or “R3” exists and adheres to the corresponding data range. After the data flow has completed execution, the data dependency description may be used to confirm that the targets represented by “Xyz” and “Pqr” have been created, and that the target represented by “Xyz” contains a data range spanning the previous day. If the data flow successfully completes, notifications of the successful completion (e.g., “successNotifications”) may be transmitted over email to handles of “johnsmith”, “tombrody”, and “evansilver.” If the data flow does not complete successfully, notifications of an unsuccessful completion (e.g., “failureNotifications”) may be transmitted over email to handles of “tombrody” and “dwh_operation.”

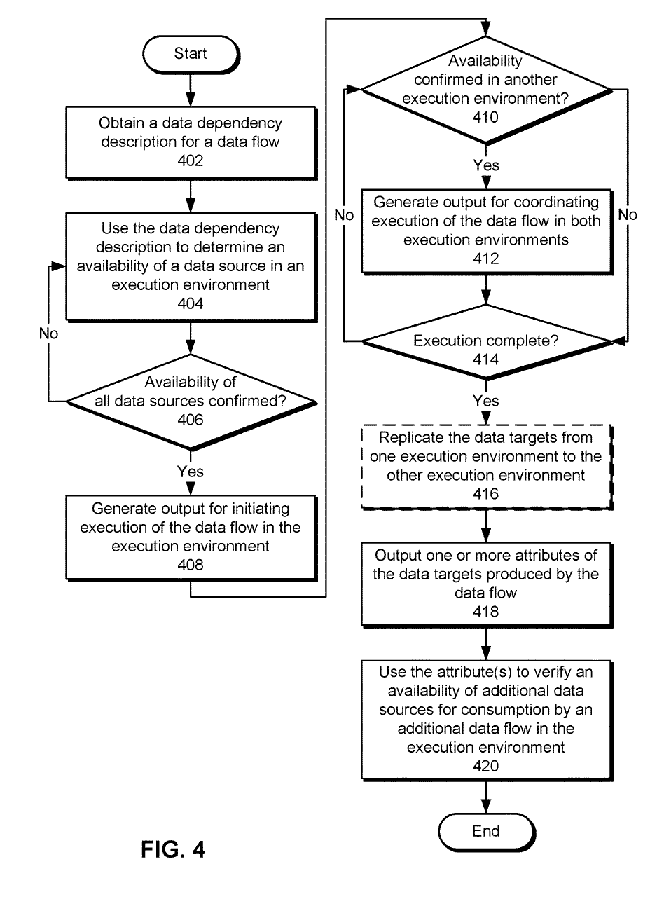

FIG. 4 shows a flowchart illustrating the process of managing execution of a data flow in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a data dependency description for a data flow is obtained (operation 402). The data dependency description may identify data sources to be consumed by the data flow, data targets to be produced by the data flow, and data ranges associated with some or all of the data sources and/or data targets. The data dependency may be created by aggregating the data sources, data targets, and/or data ranges from jobs in the data flow.

Next, the data dependency description is used to determine an availability of a data source in an execution environment (operation 404). For example, the data dependency description may be used to identify, in the execution environment, a data set representing the data source. The data set may be identified using a path, cluster, type of data source, and/or other information for the data source in the data dependency description. If the data dependency description specifies a data range of the data source, the data range may also be verified using log data, transaction data, and/or the contents of the data set.

Operation 404 may be repeated until the availability of all data sources in the execution environment is confirmed (operation 406). For example, the availability of each data source in the data dependency description may be checked until all data sources are confirmed to be available in the execution environment.

Once the availability of all data sources is confirmed, output for initiating execution of the data flow in the execution environment is generated (operation 408). For example, the output may include a notification or indication of the availability of the data sources for use in executing the data flow in the execution environment. The output may also, or instead, include a signal and/or trigger to initiate the data flow in the first execution environment.

The availability of all data sources may also be confirmed in another execution environment (operation 410), independently of the verification of data availability in the original execution environment. For example, the availability in the other execution environment may be confirmed after versions of the data sources in the other execution environment are verified to exist and/or have the corresponding data ranges. If the availability is confirmed in the other execution environment, output for coordinating execution of the data flow in both execution environments is generated (operation 412). For example, the output may be used to balance a load associated with the data flow between the execution environments, maximize utilization of computing resources in both execution environments, and/or select one of the execution environments for executing the data flow. If the availability is not confirmed in the other execution environment, output for coordinating execution of the data flow between the environments may be omitted.

Execution of the data flow may continue in one or both execution environments until the execution completes (operation 414). While the data flow executes, additional output for coordinating execution of the data flow between the execution environments may be generated (operation 412) based on the availability of the data sources in the other execution environment (operation 410). For example, the data flow may initially execute in one execution environment while the availability of all data sources remains unconfirmed for the other execution environment. After the data sources are confirmed to be available in the other execution environment, the data flow may execute on both environments and/or the environment with the most computational resources available for use by the data flow.

After the execution of the data flow completes, the data targets may optionally be replicated from one execution environment to the other (operation 416). For example, the data targets may be replicated when the data flow is executed on only one execution environment and/or some of the data targets are produced on only one execution environment.

One or more attributes of the data targets produced by the data flow may also be outputted (operation 418). For example, identifiers, completion times, and/or data ranges of the data targets may be outputted to confirm successful completion of the data flow. Finally, the attribute(s) are used to verify an availability of additional data sources for consumption by an additional data flow in the execution environment (operation 420). For example, the attribute(s) may be matched to data sources in the data dependency description of the additional data flow to confirm the availability of the data sources for the additional data flow. The attribute(s) may thus expedite the verification of data readiness for the additional data flow, which in turn may facilitate efficient execution of the additional data flow.

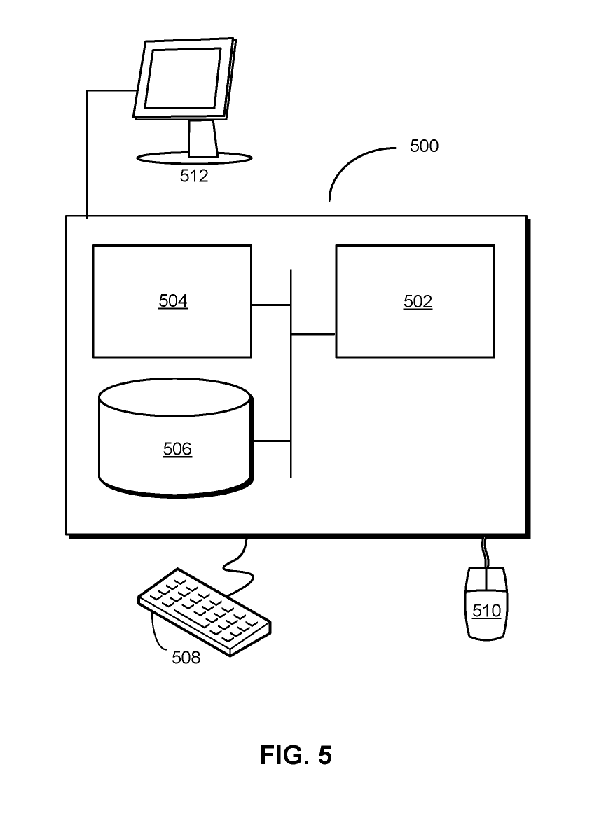

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for managing execution of a data flow. The system includes an aggregation apparatus and a verification apparatus, one or both of which may alternatively be termed or implemented as a module, mechanism, or other type of system component. The aggregation apparatus may obtain a data dependency description for a data flow, which contains data sources to be consumed by the data flow, data targets to be produced by the data flow, and one or more data ranges associated with the data sources and the data targets. Next, the verification apparatus may use the data dependency description to determine an availability of the data sources in an execution environment. After the availability of the data sources in the execution environment is confirmed, the verification apparatus may generate output for initiating execution of the data flow in the execution environment.

In addition, one or more components of computer system 500 may be remotely located and connected to the other components over a network. Portions of the present embodiments (e.g., aggregation apparatus, verification apparatus, data repository, etc.) may also be located on different nodes of a distributed system that implements the embodiments. For example, the present embodiments may be implemented using a cloud computing system that manages the execution of data flows in a set of remote execution environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a data dependency description for a data flow, wherein the data dependency description comprises data sources to be consumed by the data flow, data targets to be produced by the data flow, and one or more data ranges associated with the data sources and the data targets;
using the data dependency description to determine, by a computer system, an availability of the data sources in a first execution environment; and
after the availability of the data sources in the first execution environment is confirmed, generating output for initiating execution of the data flow in the first execution environment.

2. The method of claim 1, further comprising:
when the availability of the data sources in a second execution environment is confirmed, generating output for coordinating execution of the data flow in the first and second execution environments.

3. The method of claim 2, wherein coordinating execution of the data flow comprises at least one of:
balancing a load associated with the data flow between the first and second execution environments; and
selecting an execution environment from the first and second execution environments for executing the data flow.

4. The method of claim 1, further comprising:
after the data flow has completed execution in the first execution environment, replicating the data targets from the first execution environment to a second execution environment.

5. The method of claim 1, further comprising:
after the data flow has completed execution in the first execution environment, outputting one or more attributes of the data targets produced by the data flow.

6. The method of claim 5, further comprising:
using the one or more attributes to verify an availability of additional data sources for consumption by an additional data flow in the first execution environment.

7. The method of claim 5, wherein the one or more attributes comprise:
an identifier for a data target; and
a data range in the data target.

8. The method of claim 1, wherein using the data dependency description to determine the availability of the data sources in the first execution environment comprises:
using the data dependency description to identify, in the first execution environment, a data set representing a data source; and
verifying a data range of the data source in the data set.

9. The method of claim 1, wherein generating the output for initiating execution of the data flow in the first execution environment comprises at least one of:
outputting a notification of the availability of the data sources for use in executing the data flow in the first execution environment; and
outputting a signal to initiate the data flow in the first execution environment.

10. The method of claim 1, wherein obtaining the data dependency description for the data flow comprises:
aggregating the data sources and the data targets from a set of jobs in the data flow.

11. An apparatus, comprising:
one or more processors; and
memory storing instructions that, when executed by the one or more processors, cause the apparatus to:
obtain a data dependency description for a data flow, wherein the data dependency description comprises data sources to be consumed by the data flow, data targets to be produced by the data flow, and one or more data ranges associated with the data sources and the data targets;
use the data dependency description to determine an availability of the data sources in a first execution environment; and
after the availability of the data sources in the first execution environment is confirmed, generate output for initiating execution of the data flow in the first execution environment.

12. The apparatus of claim 11, wherein the memory further stores instructions that, when executed by the one or more processors, cause the apparatus to:
generate output for coordinating execution of the data flow in the first and second execution environments when the availability of the data sources in a second execution environment is confirmed.

13. The apparatus of claim 12, wherein coordinating execution of the data flow comprises at least one of:
balancing a load associated with the data flow between the first and second execution environments; and
selecting an execution environment from the first and second execution environments for executing the data flow.

14. The apparatus of claim 11, wherein the memory further stores instructions that, when executed by the one or more processors, cause the apparatus to:
replicate the data targets from the first execution environment to a second execution environment after the data flow has completed execution in the first execution environment.

15. The apparatus of claim 11, wherein the memory further stores instructions that, when executed by the one or more processors, cause the apparatus to:
output one or more attributes of the data targets produced by the data flow after the data flow has completed execution in the first execution environment; and
use the one or more attributes to verify an availability of additional data sources for consumption by an additional data flow in the first execution environment.

16. The apparatus of claim 11, wherein using the data dependency description to determine the availability of the data sources in the first execution environment comprises:
using the data dependency description to identify, in the first execution environment, a data set representing a data source; and
verifying a data range of the data source in the data set.

17. The apparatus of claim 11, wherein generating the output for initiating execution of the data flow in the first execution environment comprises at least one of:
outputting a notification of the availability of the data sources for use in executing the data flow in the first execution environment; and
outputting a signal to initiate the data flow in the first execution environment.

18. The apparatus of claim 11, wherein obtaining the data dependency description for the data flow comprises:
aggregating the data sources and the data targets from a set of jobs in the data flow.

19. A system, comprising:
an aggregation module comprising a non-transitory computer-readable medium comprising instructions that, when executed, cause the system to:
obtain a data dependency description for a data flow, wherein the data dependency description comprises data sources to be consumed by the data flow, data targets to be produced by the data flow, and one or more data ranges associated with the data sources and the data targets and
a verification module comprising a non-transitory computer-readable medium comprising instructions that, when executed, cause the system to:
use the data dependency description to determine an availability of the data sources in a first execution environment; and
generate output for initiating execution of the data flow in the first execution environment after the availability of the data sources in the first execution environment is confirmed.

20. The system of claim 19, wherein using the data dependency description to determine the availability of the data sources in the first execution environment comprises:
using the data dependency description to identify, in the first execution environment, a data set representing a data source; and
verifying a data range of the data source in the data set.
